(19) United States
(12) Patent Application Publication
(10) Pub. No.: US 2025/0326054 A1
(43) Pub. Date: Oct. 23, 2025

(54) LASER MARKING DEVICE

(71) Applicants: DINKLE ENTERPRISE CO., LTD., New Taipei City (TW); DINKLE ELECTRIC MACHINERY (CHINA) CO., LTD., KUNSHAN (CN); LI YANG ELECTRIC MACHINERY (DONGGUAN) CO., LTD., Dong Guan City (CN)

(72) Inventor: Shang-Tsai WU, New Taipei City (TW)

(21) Appl. No.: 18/638,657

(22) Filed: Apr. 17, 2024

(51) Int. Cl. B23K 26/08; B23K 26/70

(52) U.S. Cl. CPC B23K 26/083; B23K 26/706

(57) ABSTRACT

A laser marking device includes a platform, a laser module and a shading mechanism. The platform has a processing area. The shading mechanism includes a shading hood, a support hood covering the laser module and at least one swing arm connected between the shading hood and the support hood. The shading hood swings toward the bottom of the laser module from the support hood to above the processing area through the swing arm. The inside of the shading hood is disposed with a positioning element. The outside of the support hood has a surface corresponding to the shading hood. The surface has a first and a second fixing position. The fixing element is fixed at the first fixing position when the shading hood uses the swing arm to move to the support hood, and fixed at the second fixing position when the swing arm moves to the processing area.

### BACKGROUND

### Technical Field

The disclosure relates to a laser processing machine, particularly to a laser marking device.

### Related Art

Laser marking machines will generate laser light during the marking operation because of laser, which may affect the vision of the operators. Therefore, a shading structure is provided on the workpiece being processed to prevent the operators from looking directly during the laser light operation.

However, since it is difficult to operate the shading protection of marking machines, it is usually necessary to continuously hold the shading structure at the top by hand, so that it cannot be put down until the processed workpiece is placed below the laser light source. Therefore, it is relatively inconvenient to operate and easily causes manual fatigue.

In view of this, the inventors have devoted themselves to the above-mentioned prior art, researched intensively and cooperated with the application of science to try to solve the above-mentioned problems. Finally, the invention which is reasonable and effective to overcome the above drawbacks is provided.

### SUMMARY

An object of the disclosure is to provide a laser marking device, which uses the swing arm to make the shading hood lifted or closed quickly, has a magnetic design to position the shading hood, and uses an adjacent design of the conveying mechanism and the distributing mechanism to reduce the overall space and achieve an object of automatically conveying materials, so that loading of workers can be reduced.

Another object of the disclosure is to provide a laser marking device, which further associates with a push switch to accomplish the object of safely starting the laser module.

To accomplish the above object, the disclosure provides a laser marking device, which includes a platform, a laser module and a shading mechanism. The platform is disposed with a conveying mechanism and a distributing mechanism. The conveying mechanism has a waiting area and a processing area. The distributing mechanism is located on the waiting area. The laser module is relatively disposed over the processing area. The shading mechanism is disposed outside the laser module and includes a shading hood, a support hood covering the laser module and at least one swing arm connected between the shading hood and the support hood. The shading hood swings toward the bottom of the laser module from the support hood to above the processing area through the swing arm. The outside of the shading hood is disposed with a handle. The inside of the shading hood is disposed with a positioning element at a position corresponding to the handle. The outside of the support hood has a surface corresponding to the shading hood. The surface has a first fixing position and a second fixing position. The positioning element is fixed at the first fixing position when the shading hood uses the swing arm to move to the support hood. The positioning element is fixed at the second fixing position when the shading hood uses the swing arm to move to the processing area.

To accomplish the above another object, the disclosure provides a laser marking device, which is further disposed with a push switch at the second fixing position mentioned above. The laser module cannot be started to perform a marking process until the push switch is touched so as to guarantee workers' safety.

### BRIEF DESCRIPTION OF THE DRAWINGS

FIG. 1 is a perspective schematic view of the disclosure;

FIG. 2 is a partially perspective schematic view of the disclosure from another perspective;

FIG. 3 is a cross-sectional schematic view of the marking materials stacked on the waiting area of the disclosure;

FIG. 4 is a schematic view of action of the distributing mechanism according to FIG. 3;

FIG. 5 is a partially enlarged cross-sectional view of the conveying mechanism sending the marking materials to the processing area of the disclosure;

FIG. 6 is a cross-sectional schematic view of the conveying mechanism of the disclosure;

FIG. 7 is a cross-sectional view of the shading mechanism of the disclosure; and

FIG. 8 is a schematic view of action of the shading mechanism of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

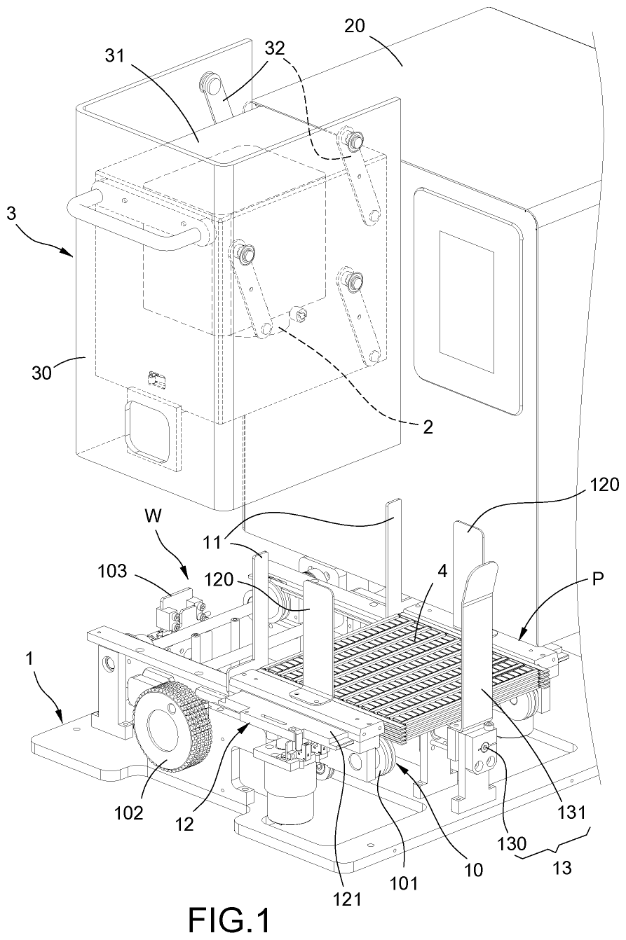

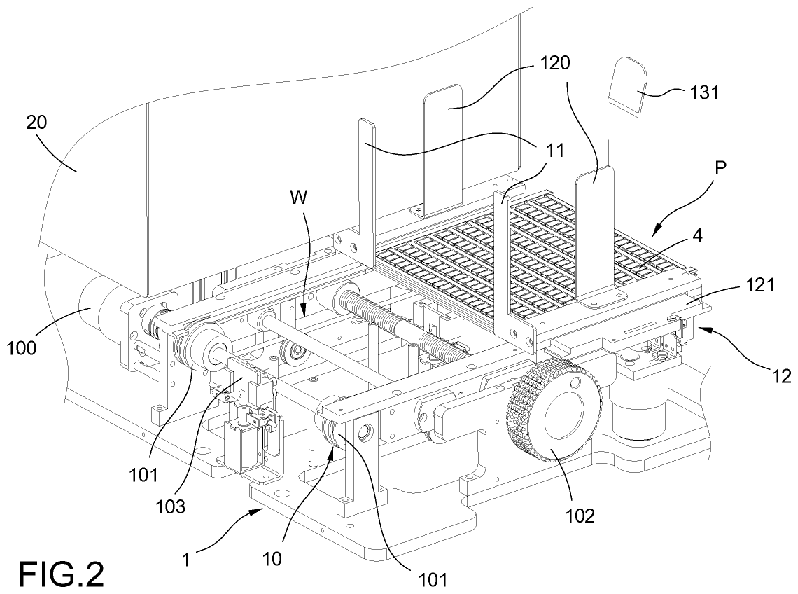

Please refer to FIGS. 1 and 2, which are a perspective schematic view and a partially perspective schematic view of the disclosure from another perspective. The disclosure provides a laser marking device, which includes a platform 1, a laser module 2 relatively disposed over the platform 1 and a shading mechanism 3 disposed on the laser module 2 and movable toward the platform 1.

The platform 1 is disposed with a conveying mechanism 10 for feeding one or more marking materials 4. An end of the conveying mechanism 10 has a waiting area P and the other end has a processing area W. A limiting blocker plate 11 is disposed between the waiting area P and the processing area W. In the shown embodiment of the disclosure, the limiting blocker plate 11 may be composed of two L-shaped plates which are oppositely arranged at an interval to block lateral edges of the marking materials 4 and limit them in the waiting area P. The marking materials 4 may be stacked in the waiting area P and are conveyed toward the processing area W one by one by the conveying mechanism 10. The laser module 2 is relatively located over the processing area W to perform laser marking to the marking materials 4 sent in the processing area W.

Continuing the above description, the laser module 2 is used to perform laser marking to the marking materials 4, which may use a control system 20 to perform programmable control. The control system 20 may be a computer to control characters, patterns or figures marked by the laser module 2.

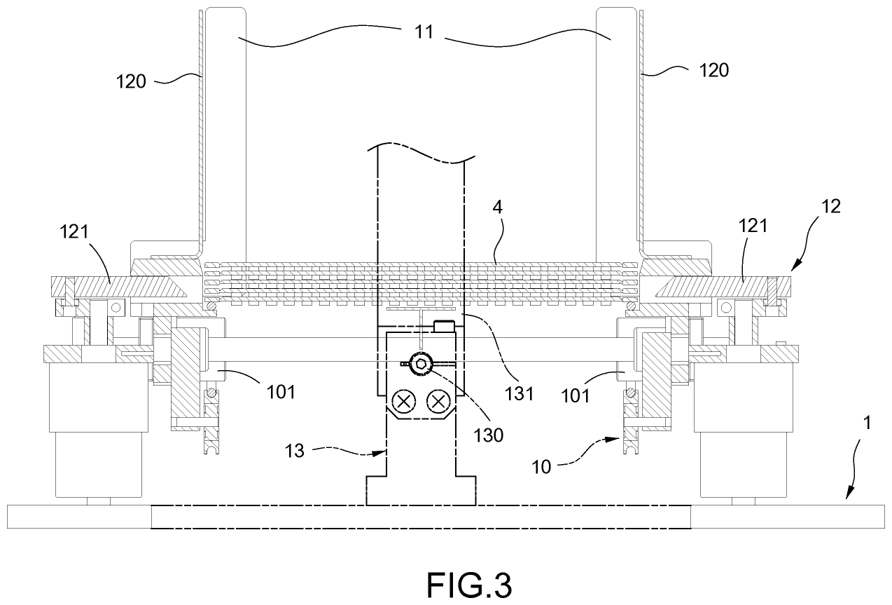

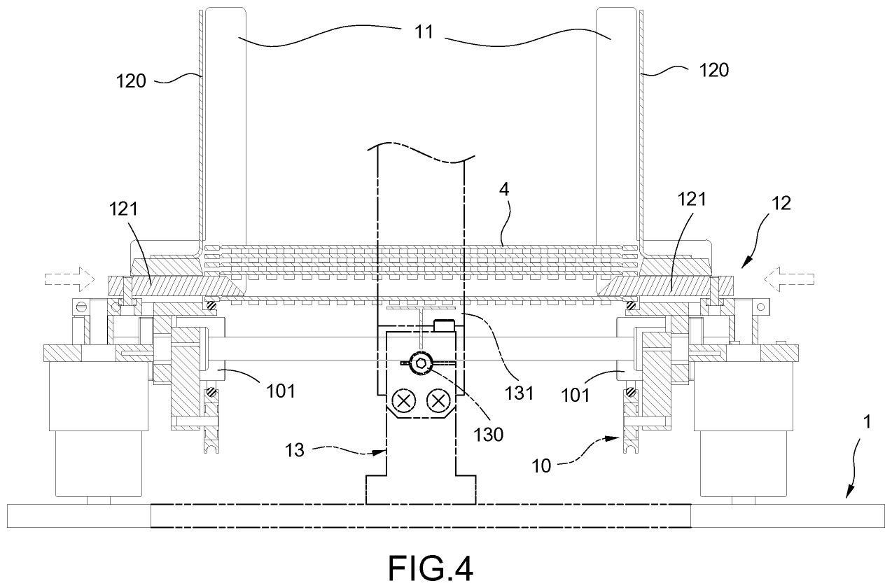

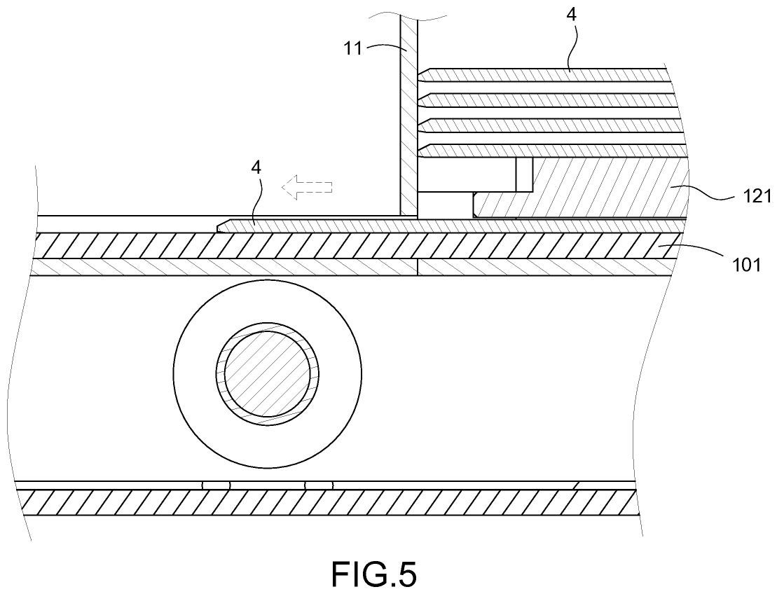

Please refer to FIGS. 1-3. The platform 1 is further disposed with a distributing mechanism 12 and an adjusting assembly 13 disposed at an end of the waiting area P, which is away from the processing area W. The distributing mechanism 12 includes two distributing arms 120 located on two sides of the waiting area P. The two distributing arms 120 are arranged approximately correspondingly to the width of each marking material 4. A wedge plate 121 is disposed under each distributing arm 120. The two wedge plates 121 may be moved toward each other relatively to lift all of the multiple marking materials 4 stacked in the waiting area P except the lowermost one (as shown in FIG. 4) so that the conveying mechanism 10 only sends the lowermost marking material 4 to the processing area W via the region under the limiting blocker plate 11 (as shown in FIG. 5). The adjusting assembly 13 has an adjusting rod 130 and a stopping portion 131 which is movable on the adjusting rod 130. The stopping portion 131 may match with the limiting blocker plate 11 to correspond to the length of each marking material 4 to be adjusted by the adjusting rod 130 so as to be suitable for placing the marking materials 4 with different length sizes in the waiting area P.

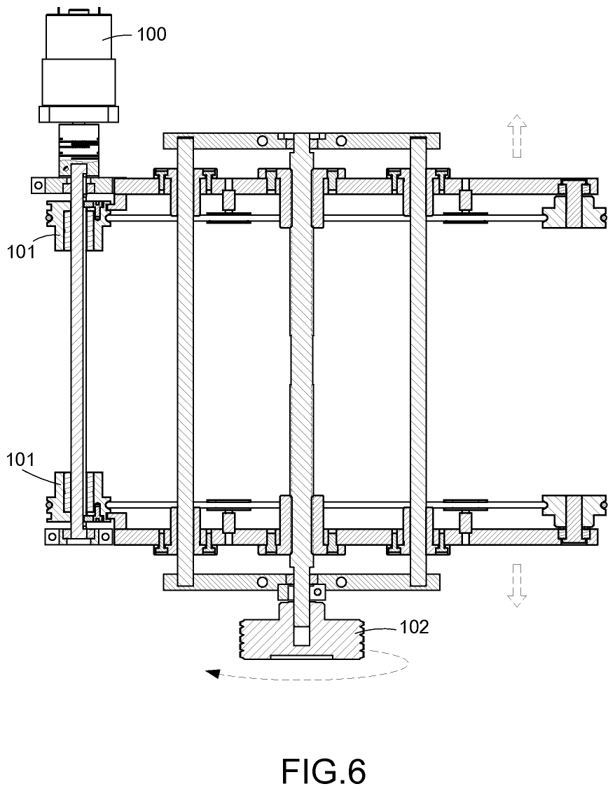

Further, as shown in FIG. 6, the conveying mechanism 10 may include a driving motor 100 and two conveying rails 101 driven by the driving motor 100. The two conveying rails 101 may be composed of belt pulleys. The two conveying rails 101 are arranged at an interval and screwed by an adjusting bolt 102 so that the distance between the two conveying rails 101 may be adjusted by the adjusting bolt 102 to be further suitable for the marking materials 4 with different width sizes. In addition, please further refer to FIGS. 1 and 2; the conveying mechanism 10 is disposed with an unloading limiting module 103 at an end of the processing area W, which is away from the waiting area P. When the marking materials 4 are marked in the processing area W by the laser module 2, the unloading limiting module 103 just rises to prevent the marking materials 4 from falling. And after the marking process has been finished, the unloading limiting module 103 lowers to make the marking materials 4 withdraw from the processing area W along the conveying mechanism 10 and be received by a container (not shown) outside the unloading limiting module 103 to accommodate the finished marking materials 4 in the container.

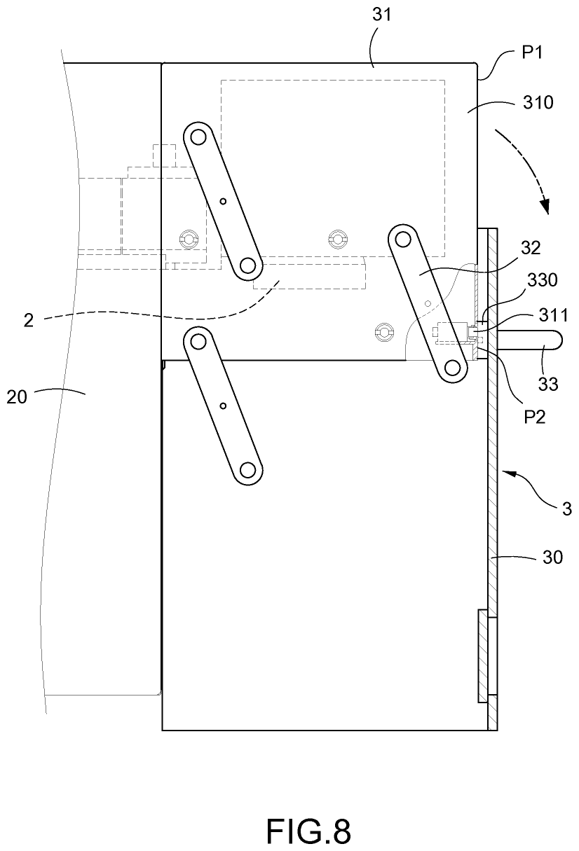

As shown in FIGS. 1, 7 and 8, the shading mechanism 3 is disposed outside the laser module 2 and includes a shading hood 30, a support hood 31 covering the laser module 2 and at least one swing arm 32 connected between the shading hood 30 and the support hood 31. The shading hood 30 may swing toward the bottom of the laser module 2 from the support hood 31 to above the processing area W through the swing arm 32 (as shown in FIG. 8) so as to make the shading hood 30 covered on the processing area W to block laser rays for protection during the laser engraving process by the lase module 2.

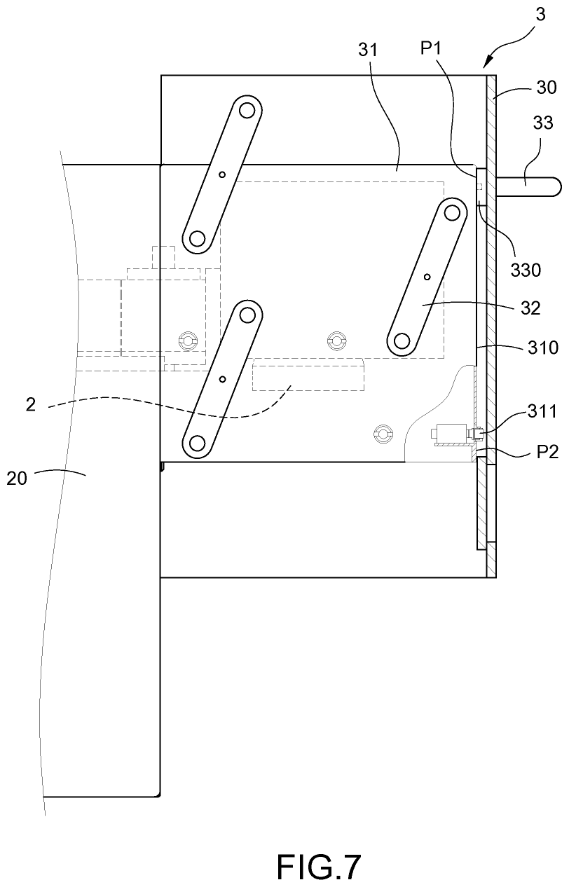

In addition, as shown in FIGS. 7 and 8, the outside of the shading hood 30 is disposed with a handle 33, and the inside of the shading hood 30 is disposed with a positioning element 330 at a position corresponding to the handle 33. The positioning element 330 may be a magnet, a suction disk or a fastener. The outside of the support hood 31 includes a surface 310 corresponding to the shading hood 30. The surface 310 has a first fixing position P1 and a second fixing position P2. The surface 310 may be made of a material which may be attracted by a magnetic element, such as iron, or only the first fixing position P1 and the second fixing position P2 adapt the aforementioned material to be advantageous to the positioning element 330 adapting a magnet attraction manner, or adapting a surface made of glass or acrylic to be advantageous to the positioning element 330 using a suction disk to make adsorption, or may be disposed with an engaging slot or a fastening hole to be advantageous to the positioning element 330 fastening with each other by engagement. When the shading hood 30 uses the swing arm 32 to swing upward, the positioning element 330 can be fixed at the first fixing position P1 (as shown in FIG. 7) and goes away from the processing area W of the platform 1. When the shading hood 30 uses the swing arm 32 to swing downward, the positioning element 330 is fixed at the second fixing position P2 (as shown in FIG. 8) and covers the processing area W of the platform 1. When the shading hood 30, positioned by the positioning element 330, is located at the first fixing position P1, the shading hood 30 can be easily lifted. When the shading hood 30, positioned by the positioning element 330, is located at the second fixing position P2, the shading hood 30 can stably cover on the processing area W. Further, the second fixing position P2 is disposed with a push switch 311. The laser module 2 cannot be started to perform marking by the control system 20 until the push switch 311 is pushed by the positioning element 330 so as to further provide a safety mechanism during the processing.

Therefore, the laser marking device of the disclosure can be obtained by the above structure.

While this disclosure has been described by means of specific embodiments, numerous modifications and variations could be made thereto by those skilled in the art without departing from the scope and spirit of this disclosure set forth in the claims.

What is claimed is:

1. A laser marking device comprising:
a platform, disposed with a conveying mechanism and a distributing mechanism, the conveying mechanism comprising a waiting area and a processing area, and the distributing mechanism being located on the waiting area;
a laser module, relatively disposed over the processing area; and
a shading mechanism, disposed outside the laser module, comprising a shading hood, a support hood covering the laser module and at least one swing arm connected between the shading hood and the support hood, and the shading hood swinging toward a bottom of the laser module from the support hood to above the processing area through the swing arm;
wherein an outside of the shading hood is disposed with a handle, an inside of the shading hood is disposed with a positioning element at a position corresponding to the handle, an outside of the support hood comprises a surface corresponding to the shading hood, the surface comprises a first fixing position and a second fixing position, the positioning element is fixed at the first fixing position when the shading hood uses the swing arm to move to the support hood, and the positioning element is fixed at the second fixing position when the shading hood uses the swing arm to move to the processing area.

2. The laser marking device of claim 1, wherein the conveying mechanism comprises a driving motor and two conveying rails driven by the driving motor, and the two conveying rails are arranged at an interval.

3. The laser marking device of claim 2, wherein the two conveying rails are screwed by an adjusting bolt, and a distance between the two conveying rails is adjusted by the adjusting bolt.

4. The laser marking device of claim 1, wherein the conveying mechanism is disposed with an unloading limiting module at an end of the processing area, which is away from the waiting area.

5. The laser marking device of claim 1, wherein a limiting blocker plate is disposed between the waiting area and the processing area.

6. The laser marking device of claim 5, wherein the limiting blocker plate is composed of two L-shaped plates which are oppositely arranged at an interval.

7. The laser marking device of claim 4, wherein the platform is further disposed with an adjusting assembly located at an end of the waiting area, which is away from the processing area.

8. The laser marking device of claim 7, wherein the adjusting assembly comprises an adjusting rod and a stopping portion which is movable on the adjusting rod.

9. The laser marking device of claim 1, wherein the distributing mechanism comprises two distributing arms located on two sides of the waiting area, a wedge plate is disposed under each distributing arm, and the two wedge plates are moved toward each other relatively.

10. The laser marking device of claim 1, wherein the second fixing position is disposed with a push switch.

11. The laser marking device of claim 1, wherein the positioning element is a magnet, a suction disk or a fastener.
